(19) United States
(12) Patent Application Publication
(10) Pub. No.: US 2026/0349413 A1
(43) Pub. Date: Nov. 5, 2026

(54) SYSTEM COMMUNICATIONS VIA LIQUID COOLING NETWORKS

(71) Applicant: Dell Products L.P., Round Rock, TX (US)

(72) Inventors: CARLOS GUILLERMO HENRY, Georgetown, TX (US); CHRIS EVERETT PETERSON, Austin, TX (US); DOMINICK ADAM LOVICOTT, Jarrell, TX (US); JAMES ANDREW ALBRITTON, Austin, TX (US); JUAN TORRES-GONZALEZ, Round Rock, TX (US)

(21) Appl. No.: 19/194,328

(22) Filed: Apr. 30, 2025

(51) Int. Cl. G05B 19/4155

(52) U.S. Cl. CPC G05B 19/4155; G05B 2219/49216

(57) ABSTRACT

Methods, systems, and devices are provided for managing operation of a system. To do so, an identification of an occurrence of a management event for the system may be made by a first component of the system. Based on the identification, a portion of data to transmit to a second component of the system may be obtained based on the occurrence of the management event and by the first component. A determination is made regarding whether the first component is in fluid communication with the second component via a fluid bus. If it is determined that the first component is in the fluid communication with the second component, an acoustic wave may be coupled to the fluid bus by the first component to direct the acoustic wave to the second component to transmit the portion of the data to the second component to manage the occurrence of the management event.

### FIELD

Embodiments disclosed herein relate (generally) to management of systems. More particularly, embodiments disclosed herein relate to systems and methods for facilitating additional communication options for a distributed system.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIGS. 1A-1B show block diagrams illustrating a system in accordance with an embodiment.

FIG. 2 shows a diagram illustrating a system in accordance with an embodiment.

FIG. 3 shows a flow diagram illustrating a method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary de vices, such as in a network topology.

In general, embodiments disclosed herein relate to methods and systems for managing a (distributed) system. The system may provide computer-implemented services. To do so, operation of hardware components may facilitate various functionalities of the system, a byproduct of such operation resulting in a generation of heat.

If the generated heat is not properly regulated (e.g., dissipated), the hardware components may be damaged due to a buildup of the generated heat that is beyond the thermal range (e.g., beyond thermal operating limits) for optimal operation of the system.

Consequently, damage to the hardware components may cause workloads performed by the hardware components and/or facilitated functionalities of the system to be lost (referred to as “workload loss”) and/or otherwise deprecated (resulting in less-than-optimal operation of the system at best). Such loss and/or deprecation may, in turn, negatively impact (e.g., delay and/or prevent entirely) the system's providing of the computer-implemented services.

To increase the likelihood of placing the system in the operable conditions (therefore increasing a likelihood of the computer implemented services being provided as expected and/or desired by a consumer of such services), the system may include a liquid cooling system (e.g., loop) that includes a fluid bus adapted to distribute cooling fluid to a first component and a second component of the system.

However, to facilitate operable conditions of the system, various portions of data may be required by various portions of the system to (i) regulate such heat and/or to (ii) otherwise provide the computer implemented services, with such various portions of the system at risk of being in contention for facilitating transmissions of such data. Consequently, should transmissions of such data be delayed and/or otherwise prevented entirely by such contentions, the computer implemented services may also be delayed and/or prevented entirely from being provided as desired by the consumer of such services.

Therefore, to increase the likelihood of providing such services as desired, the system may utilize a method for an additional/alternative means of communication throughout the system in order to reduce the likelihood of contentions of data transmissions throughout the system and/or to accompanying systems from said system.

In doing so, stable, consistent, and likely to be desirable operation of the system is more likely to be facilitated and maintained. Such operation may thereby mitigate operation within the (distributed) system being deemed undesirable, unpredictable, and/or deemed what may otherwise be negatively impacting the providing of the computer-implemented services.

In an embodiment, a method for managing operation of a system is provided.

The method may include making, by a first component of the system, an identification of an occurrence of a management event for the system; and based on the identification: obtaining, by the first component and based on the occurrence of the management event, a portion of data to transmit to a second component of the system; making a determination regarding whether the first component and the second component are in fluid communication via a fluid bus; and in a first instance of the determination where the first component and the second component are in the fluid communication via the fluid bus: coupling, by the first component, an acoustic wave to the fluid bus to direct the acoustic wave to the second component to transmit the portion of the data to the second component to manage the occurrence of the management event.

The fluid bus may include a liquid cooling loop adapted to distribute cooling fluid to the first component and the second component.

The liquid cooling loop may be adapted to circulate the cooling fluid, and the acoustic wave is coupled to the cooling fluid by the first component.

The first component may be a cooling component, and the second component is a fluid flow control component.

The fluid flow control component may be a pump, and the cooling component may be a cold plate positioned with a hardware component used by the system to provide desired computer implemented services.

The acoustic wave may be coupled to the fluid bus while the fluid bus is not under contention for communication use by other components of the system.

The acoustic wave may be coupled to the fluid bus while acoustic conditions in the fluid bus meet criteria.

The method may further include generating, by the first component and using a transducer, the acoustic wave.

The transducer may be acoustically coupled to a cooling fluid in the fluid bus.

The transducer may include one selected from a list consisting of a piezoelectric component to generate the acoustic wave; and an actuator to generate the acoustic wave.

The actuator may include: a first portion positioned in the fluid bus, and a second portion positioned outside of the fluid bus, the first portion being coupled to the second portion while at a distance from the second portion.

In an embodiment, a non-transitory media is provided. The non-transitory media may include instructions that when executed by a processor cause the computer-implemented method to be performed.

In an embodiment, a system is provided. The system may include the non-transitory media and a processor and may perform the computer-implemented method when the computer instructions are executed by the processor.

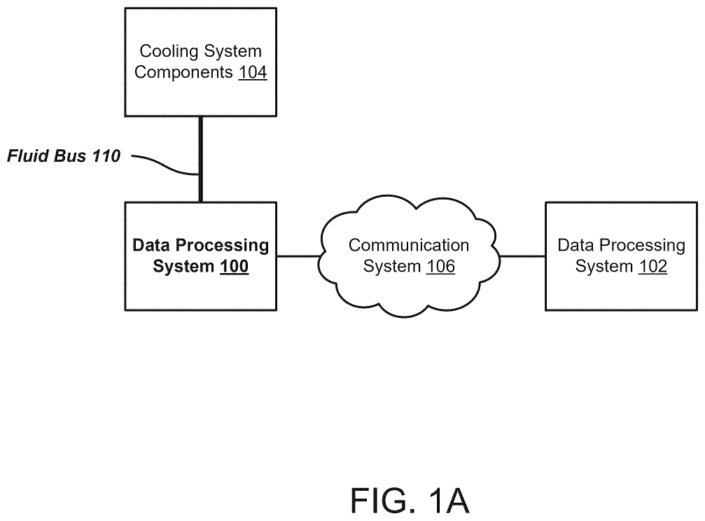

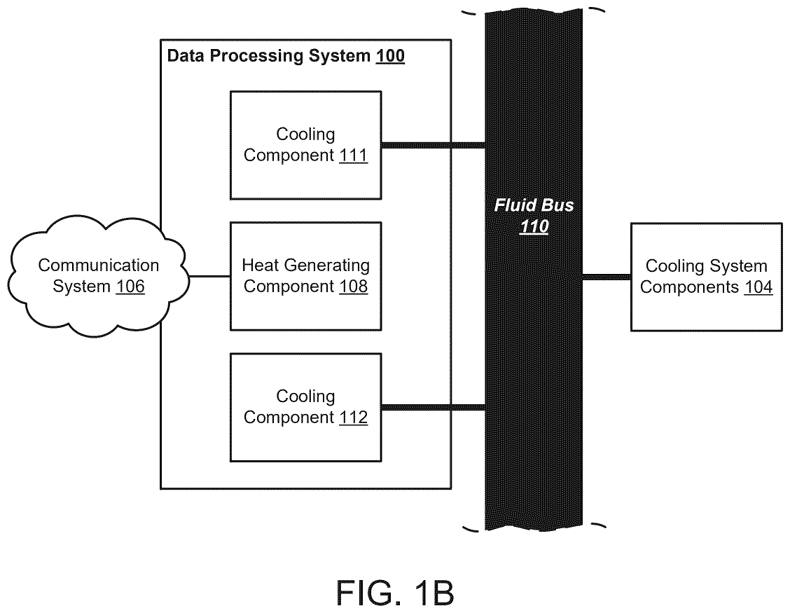

Turning to FIG. 1A, a first block diagram illustrating a system in accordance with an embodiment is shown. The system shown in FIG. 1A may provide for management of systems that may provide, at least in part, computer-implemented services (e.g., to user of the system and/or devices operably connected to the system).

The system may include any number of data processing systems, such as data processing system 100 (e.g., any number of computing devices, such as in a distributed system). Each of these data processing systems may include any number of hardware components (e.g., processors, memory modules, storage devices, communication devices, etc.). The hardware components may support execution of any number and types of applications (e.g., software components). Changes in available functionalities of the hardware and/or software components may provide for various types of different computer-implemented services to be provided over time.

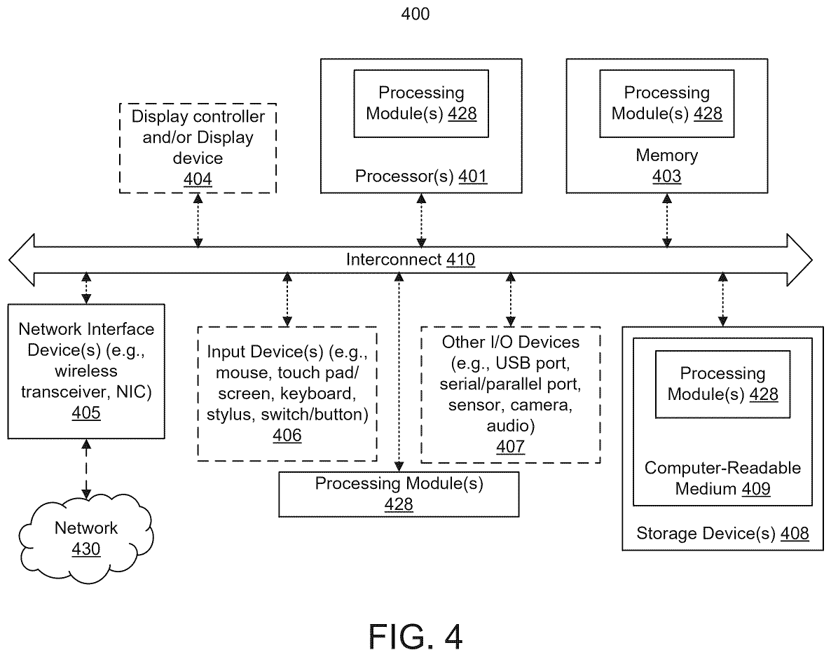

Refer to FIG. 1B for additional details regarding data processing system 100 and FIG. 4 for additional details regarding computing devices.

The computer-implemented services may include any type and quantity of computer-implemented services. The computer-implemented services may include, for example, database services, data processing services, electronic communication services, and/or any other services that may be provided using one or more computing devices. The computer-implemented services may be provided by, for example, any components of data processing system 100, and/or any other type of devices (not explicitly shown in FIG. 1A).

Other types of computer-implemented services may be provided by the (distributed) system shown in FIG. 1A without departing from embodiments disclosed herein.

The computer-implemented services may be provided, at least in part, for example, based on operation of any hardware components of data processing system 100. To provide the computer-implemented services reliably, the system may regulate heat generated during operation of such hardware components (e.g., of data processing system 100) using, for example, a liquid cooling system (e.g., loop).

If the generated heat is not properly regulated (e.g., dissipated), the hardware components may be damaged due to a buildup of the generated heat that is beyond the thermal range (e.g., beyond thermal operating limits) of the system.

Consequently, damage to the hardware components may cause workloads performed by the hardware components and/or facilitated functionalities of the system to be lost (referred to as “workload loss”) and/or otherwise deprecated (resulting in less-than-optimal operation of the system at best). Such loss and/or deprecation may, in turn, negatively impact (e.g., delay and/or prevent entirely) the system's providing of the computer-implemented services.

To increase the likelihood of placing the system in the operable conditions (therefore increasing a likelihood of the computer implemented services being provided as expected and/or desired by a consumer of such services), the system may include a liquid cooling system (e.g., loop) that includes a fluid bus adapted to distribute cooling fluid to, at least, a first component and a second component of the system.

Additionally, to further facilitate operable conditions of the system, for example, various portions of data may be required by various portions of the system to (i) regulate such heat and/or to (ii) otherwise provide the computer implemented services, with such various portions of the system at risk of being in contention for facilitating transmissions of such data.

Consequently, should transmissions of such data be delayed and/or otherwise prevented entirely by such contentions, the computer implemented services may also be delayed and/or prevented entirely from being provided as desired by the consumer of such services.

Therefore, to increase the likelihood of providing such services as desired, the system may utilize a method for an additional/alternative means of communication throughout the system (e.g., via the fluid bus) in order to reduce the likelihood of contentions of data transmissions throughout the system and/or to accompanying systems from said system.

In doing so, stable, consistent, and likely to be desirable operation of the system is more likely to be facilitated and maintained. Such operation may thereby mitigate operation within the (distributed) system being deemed undesirable, unpredictable, and/or deemed what may otherwise be negatively impacting the providing of the computer-implemented services.

In general, embodiments disclosed herein relate to systems, devices, and methods for managing operation of a (distributed) system. To manage the operation of the system, the system may utilize a fluid bus (e.g., 110) for communication throughout the system, and/or to accompanying systems from said system, rather than (e.g., solely) relying on using electronic communication channels. In doing so, stable, consistent, and likely to be desirable operation of the management controller is more likely to be facilitated and maintained. Such operation may thereby mitigate operation within the distributed system being deemed undesirable, unpredictable, and/or deemed what may otherwise be negatively impacting the providing of the computer-implemented services.

To provide the above noted functionality, the system may include data processing system 100, data processing system 102, cooling system components 104, fluid bus 110, and communication system 106. Each of these is discussed below.

Data processing systems 100 and 102 may each include any number of hardware components that may individually and/or cooperatively provide at least a portion of the computer-implemented services. At least a portion of any of these hardware components may be cooled by a liquid cooling system (e.g., loop) to regulate heat generated during respective (hardware) component operation (e.g., any of these hardware components may be cooled by any of cooling system components 104, discussed further below).

While providing at least a portion of the computer-implemented services, a data processing system (e.g., 100) may communicate with and/or obtain information from at least a portion of cooling system components 104, and/or any other cooling components not explicitly shown in FIG. 1A, but that may nonetheless be included in the system as discussed, for example, further below with regard to a first and/or a second (cooling) component (e.g., refer to FIGS. 1B-3).

Cooling system components 104 may cool any portions of the system via different means. Such means of cooling may include, for example, (i) air-based cooling, (ii) liquid-based cooling, and/or (iii) any other “-based” cooling not to be limited by embodiments discussed herein. For example, cooling system components 104 may be a combination of liquid and/or air heat transport/dissipation-based cooling (e.g., liquid/air-based cooling) components. To provide its functionality, such cooling components as those included in cooling system components 104 may be implemented by, for example, fans, liquid cooling blocks (e.g., cold plates), fluid lines, manifolds, pumps, etc.

To communicate with and/or obtain information from at least a portion of cooling system components 104, data processing system 100 may utilize, for example, fluid bus 110, as shown in FIG. 1A and discussed below.

Fluid bus 110 may be adapted to (i) distribute cooling fluid to (at least) a first component and a second component of the system, and (ii) facilitate transmissions of portions of data (e.g., the previously mentioned data on whose successful and timely transmission throughout the system (and/or to accompanying systems from said system) the providing of the computer implemented services may depend). Fluid bus 110 may facilitate such transmitting of the portions of data via acoustic waves coupled to liquid coolant (e.g., cooling liquid/cooling fluid) of fluid bus 110.

For example, to provide its functionality, fluid bus 110 may be implemented by a liquid cooling loop adapted to distribute cooling fluid to various components of the system, shown and discussed further below with regard to FIGS. 1B, 2, and 3.

Therefore, data processing system 100 may utilize fluid bus 110 to communicate with and/or obtain information from at least a portion of cooling system components 104 by facilitating, for example, a method for an additional/alternative means of communication throughout the system via fluid bus 110.

This method that utilizes fluid bus 110 may include, for example, facilitating (i) performance of an identification of an occurrence of a management event for the system to be made by a first component of the system, (ii) based on the identification, an obtaining of a portion of data (e.g., the previously mentioned portion of data) to transmit to a second component of the system based on the occurrence of the management event and by the first component, (iii) performance of a determination to be made regarding whether the first component is in fluid communication with the second component via the fluid bus (e.g., 110), and if it is determined that the first component is in the fluid communication with the second component, (iv) a coupling of an acoustic wave to the fluid bus (e.g., 110) by the first component to direct the acoustic wave to the second component to thereby transmit the portion of the data to the second component to manage the occurrence of the management event.

Thus, while providing their functionality, any of the above-mentioned portions of the system may provide all, or a portion, of the method(s) shown and/or discussed herein with regard to FIGS. 1A-3.

Communication system 106 may allow any data processing systems of the (distributed) system (e.g., 100-102) to communicate with one another (and/or with other devices not explicitly shown in FIG. 1A). To provide its functionality, communication system 106 may be implemented with one or more wired and/or wireless networks. Any of these networks may be a radio access network (e.g., a cellular core network), a private network (e.g., the “Network” shown in FIG. 4), a public network, and/or may include the Internet. For example, data processing system 100 may be operably connected to data processing system 102 via the Internet. Data processing system 100, data processing system 102, cooling system components 104, and/or communication system 106 may be adapted to perform one or more protocols for communicating via communication system 106.

Any of (and/or any components thereof) the system discussed above may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Thus, as shown in FIG. 1A, a system in accordance with an embodiment may manage operation of said system by utilizing a fluid bus (e.g., 110) implemented by, for example, a liquid cooling loop of the system. By doing so, the system (and/or data processing systems thereof and/or components thereof) may be more likely to provide computer implemented services as expected by a consumer of such services, without, for example, additional electronics being added to the system.

While illustrated in FIG. 1A with a limited number of specific components, a system may include additional, fewer, and/or different components without departing from embodiments disclosed herein.

Turning to FIG. 1B, a second block diagram illustrating a system in accordance with an embodiment is shown. The system shown in FIG. 1B may be data processing system 100 as discussed previously in FIG. 1A.

As shown in FIG. 1B, the previously discussed data processing system 100 may include, along with at least a portion of communication system 106 and/or fluid bus 110, (i) cooling component 111, (ii) cooling component 112, and/or (iii) heat generating component 108. Each of these is discussed below.

As mentioned previously, the system may include any number of hardware components whose operation may facilitate the providing of computer implemented services. For example, data processing system 100 may include any number of such hardware components. Such a hardware component may be, for example, heat generating component 108. Additionally, it will be appreciated that such hardware components of data processing system 100 may be operably connected to any number of other devices of other data processing systems (e.g., 102) via, for example communication system 106. Furthermore, as a byproduct of such hardware component operation, heat may be generated by such a hardware component (e.g., hence being label with part number 108 as “heat generating component 108”).

For example, assume heat generating component 108 is implemented by a processor of data processing system 100. Further assume that while performing a number of queued workloads assigned to this processor, the processor generates a significant quantity of heat that must be dissipated for operable conditions of data processing system 100 to be maintained (e.g., the operable conditions being conducive for the providing of the computer implemented services.

To regulate (e.g., via heat dissipation) the heat generated by heat generating component 108, data processing system 100 may include cooling components 111 and 112 that may be connected to one another via fluid bus 110, such connection thereby facilitating fluid communication between the two cooling components. Each of these cooling components are discussed below with additional detail.

Cooling component 111 may be implemented by, for example, a cold plate positioned with heat generating component 108, and may be adapted to facilitate (i) heat dissipation into liquid coolant (e.g., the cooling fluid) of fluid bus 110 that flows through the liquid cooling loop and proximate to heat generating component 108, and (ii) a flow of the cooling liquid through portions of the cold plate and through the rest of the liquid cooling loop that is fluid bus 110 so that the cooling fluid may flow to/through other (cooling) components such as cooling component 112, discussed below.

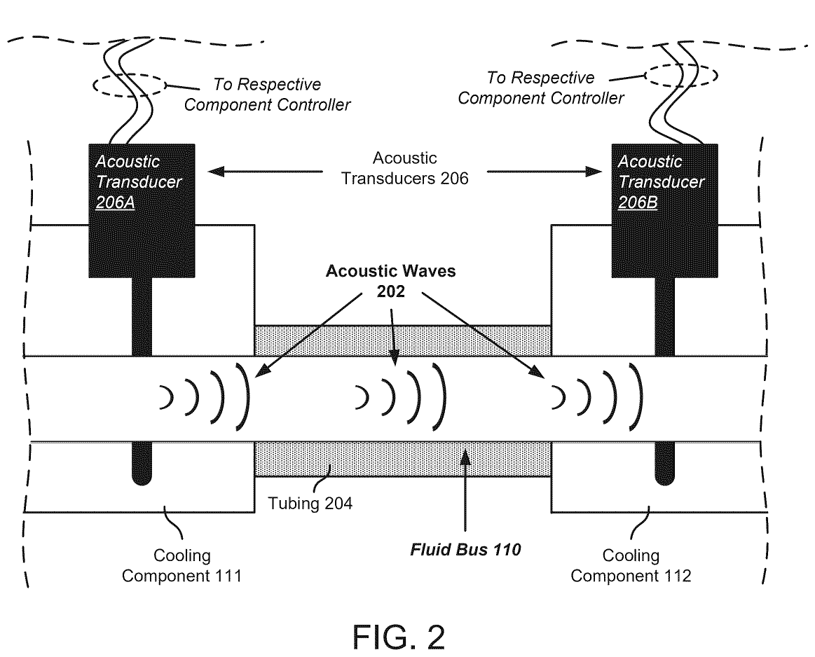

Cooling component 112 may be implemented by, for example, a fluid flow control component (e.g., a coolant distribution unit) such as a manifold or pump. Cooling component 112 may therefore be in fluid communication with cooling component 111 via fluid bus 110 as mentioned above, and may therefore, as previously discussed, communicate via fluid bus 110. Such communication via fluid bus 110 may be discussed further below with regard to FIG. 2.

It will be appreciated that in some cases, cooling system components 104 shown in both FIGS. 1A-1B may include cooling components 111-112. However, in some other cases, cooling components 111 and 112 may be included in different data processing systems and/or just different systems than that of cooling system components 104 (e.g., with the exception of them all being included in the system discussed with regard to FIG. 1A, since otherwise the examples discussed herein may contradict one another. Fluid bus 110 may thereby facilitate such fluid communications as the fluid communication throughout a (distributed) system in such other cases.

While illustrated in FIG. 1B with a limited number of specific components, a system may include additional, fewer, and/or different components without departing from embodiments disclosed herein.

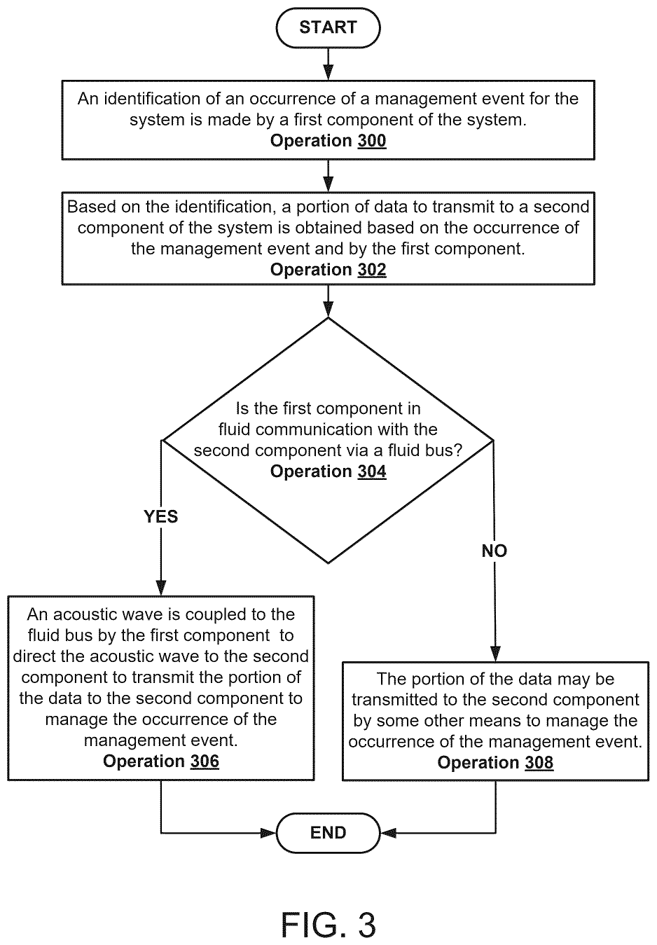

Turning to FIG. 2, a diagram illustrating a system in accordance with an embodiment is shown. The viewpoint shown in FIG. 2 may be an expanded view of the fluid communication between cooling component 111 and cooling component 112 (e.g., via fluid bus 110), as discussed above with regard to FIGS. 1A-1B, as well as discussed further below with regard to FIG. 3.

As mentioned previously, fluid bus 110 may facilitate transmissions of portions of data (e.g., the previously mentioned data whose successful and timely transmission throughout the system and/or to accompanying systems that the providing of the computer implemented services may depend) via acoustic waves coupled to liquid coolant (e.g., cooling fluid) that flows through a liquid cooling loop. Such a liquid cooling loop may be the implementation of, for example, the previously discussed fluid bus 110. Fluid bus 110 may therefore be adapted to distribute cooling fluid to various (e.g., cooling) components of the system.

Therefore, data processing system 100 may utilize fluid bus 110 to otherwise enable communications for the system components by way of an additional/alternative method of communication. Such a method may include facilitating, for example, (i) an identification of an occurrence of a management event for the system to be made by a first component (e.g., cooling component 111) of the system, (ii) based on the identification, a transmission of a portion of data to the second component (e.g., cooling component 112) of the system being obtained based on the occurrence of the management event and by the first component, (iii) a determination regarding whether the first component is in fluid communication with the second component via fluid bus 110, and if it is determined that the first component is in the fluid communication with the second component, (iv) a coupling of an acoustic wave to fluid bus 110 by the first component (111) to direct the acoustic wave to the second component (112) to transmit the portion of the data to the second component to manage the occurrence of the management event.

As shown in FIG. 2, to enable the fluid communication, data processing system 100 may include cooling components 111 and 112 and fluid bus 110, as previously discussed. To further enable the fluid communication, data processing system 100 may further include tubing 204, acoustic transducers 206, and operable connections between the acoustic transducers and respective component controllers of cooling components 111 and 112 (and/or other components/devices not to be limited by embodiments discussed herein), each of which is discussed below.

Further assume, for example, that cooling component 111 is implemented by a cold plate positioned with a heat generating component (e.g., 108) such as a processor of data processing system 100 that is performing any number of queued workloads. Furthermore, continue to assume that cooling component 112 is implemented by a pump (e.g., a fluid flow control component). This cold plate and pump may each be positioned with, for example, acoustic transducers (e.g., 206), as shown in FIG. 2. These acoustic transducers (e.g., 206A and 206B) may be operably connected with respective component controllers adapted to manage operation of their respectively positioned cooling components (e.g., 111 and 112, respectively).

Therefore, should a first respective component controller (e.g., a management controller of cooling component 111) identify an occurrence of a management event (e.g., a leak, change in workloads queued for the processor to perform, an increase in air-based cooling that may immediately begin supplementing ongoing cooling endeavors throughout the system for said system, etc.), acoustic transducer 206A may thereby receive instructions via respective operable connections from a respective component controller to generate an acoustic wave. Similarly, once sensed/identified by acoustic transducer 206B, that acoustic wave may be processed based on other respective operable connections from a respective component controller of the second component.

For example, to provide their functionality, each of transducers 206A-206B may include (i) a piezoelectric component to generate the acoustic wave, and (ii) an actuator to generate the acoustic wave, a first portion of the actuator being positioned in fluid bus 110 and a second portion of the actuator being positioned outside of fluid bus 110. for example, the first portion may be coupled to the second portion while at a distance from the second portion that enables the coupling of the acoustic wave to the cooling fluid.

Once the acoustic wave is coupled to the cooling fluid, the acoustic wave may propagate through the medium that is an implementation of the cooling fluid, as depicted in FIG. 2 by acoustic waves 202 representing the acoustic wave's simultaneous and unified traversal with the cooling fluid as the cooling fluid flows through tubing 204 (implemented by, for example, hollow, plastic tubing, thereby forming canals/channels for the cooling fluid to flow through fluid bus 110) through which the cooling fluid is directed towards cooling component 112. Transducer 206B may therefore, using its operable connection to the respective component controller of cooling component 112 (e.g., the management controller of the pump), sense and/or otherwise record an observed sensing of the acoustic wave occurring through fluid bus 110.

It will be appreciated that although shown in the diagram of FIG. 2 as originating from cooling component 111 and propagating towards cooling component 112 (e.g., a left side of the page to a right side of the page), an acoustic wave such as from acoustic waves 202 may be transmitted between any components that are in fluid communication with one another via fluid bus 110. Therefore, it may be possible for an acoustic wave to propagate from cooling component 112 to cooling component 111 (e.g., the right side of the page to the left side of the page, rather than how acoustic waves 202 is depicted in FIG. 2), and/or in any other directions enabled by the fluid bus between any two components whose fluid communication the fluid bus facilitates.

Data processing system 100 may enable the additional/alternative method of communication via fluid bus 110 between various components positioned with, and operating in collaboration with one another, cooling components positioned with fluid bus 110 such that they are in fluid communication with one another via the fluid bus.

For additional information regarding the additional/alternative method of communication, refer to the discussion of FIG. 3, further below.

While illustrated in FIG. 2 with a limited number of specific components, a system may include additional, fewer, and/or different components without departing from embodiments disclosed herein.

As discussed above, the components of FIGS. 1A-2 may perform various methods to manage a data processing system. FIG. 3 illustrates a method that may be performed by the components of the (e.g., distributed) system of FIGS. 1A-2. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method of managing operation of a system in accordance with an embodiment is shown. The method may be performed, for example, by any of the components of the system of FIGS. 1A-2 (e.g., data processing system 100), and/or other components not to be limited by embodiments disclosed herein.

At operation 300, an identification of an occurrence of a management event for the system is made by a first component of the system. The identification may be made by receiving data indicative of the identification via, for example, (i) receiving the data provided by another device in the system, (ii) obtaining the data from storage accessible to the first component, and/or (iii) by any other means not to be limited by embodiments discussed herein.

For example, assume the first component is a cooling component, as previously discussed with regard to FIG. 2. For example, this cooling component may be a cold plate positioned with a hardware component used by the distributed system to provide desired computer implemented services.

Further assume that the management event to occur is, for example, an increase in workload for the hardware component. Therefore, the data mentioned above may indicate a need for additional cooling as the increase in workload may cause the hardware component to generate additional heat. For example, if the hardware component were a processor whose functionality included performing workloads assigned to its queue, and the number of workloads assigned to its queue suddenly increased, then it may be reasonable to expect the processor to increase its consumption of computing resources, thereby also increasing its heat generation. Such data that is indicative of this increase in workloads being assigned to the queue may therefore, for example, (i) be provided to a management controller of the cold plate, (ii) be obtained from storage by the management controller of the cold plate (e.g., the data having been placed in storage by the hardware component), and/or (iii) otherwise made available to the first component by some means.

Based on obtaining such data, the first component may therefore make the identification of the occurrence of the management event for the system.

At operation 302, based on the identification, a portion of data to transmit to a second component of the system is obtained based on the occurrence of the management event and by the first component. The portion of data may be obtained by (i) being generated by the first component, (ii) being translated/relayed by the first component from the data obtained based on the hardware component, (iii) obtaining from storage after, for example, another component/device has translated/relayed from the data obtained based on the hardware component, and/or (iv) otherwise obtained based on the identification of the occurrence of the management event.

For example, assume that the first component made the identification based on receiving the previously mentioned data from the hardware component (e.g., the processor). Further assume that based on the previously mentioned data indicating the increase in the workload, that the portion of data is generated with a purpose of initiating an increase in coolant liquid flow rate through fluid lines of a liquid cooling system (e.g., loop). Therefore, the first component may generate the portion of data for this purpose. In doing so, such a purpose may be accomplished as discussed below.

For example, the second component may be a fluid flow control component. More specifically, for example, assume that this fluid flow control component is a pump. Therefore, by providing the second component (e.g., this pump) with the portion of data, the first component may cause the second component to increase the coolant liquid flow rate through fluid lines in the system once the second component obtains the portion of data and facilitates its own operation based on the portion of data.

At operation 304, a determination is made regarding whether the first component is in fluid communication with the second component via a fluid bus. The determination may be made by (i) the first component providing a signal through the liquid cooling loop via the fluid bus that automatically causes the second component to provide its own subsequent signal in return, also via the fluid bus, and that this subsequent signal is received by the first component, (ii) the first component obtaining information, for example, from another device (e.g., a processor of the system) specifying an inventory of the system and/or a configuration of the system (and/or components thereof) that may thereby be able to directly provide an answer to the determination, and/or (iii) by any other means not to be limited by embodiments discussed herein.

For example, the fluid bus may be implemented as the liquid cooling loop and may therefore be adapted to distribute cooling fluid to the first component and the second component. In this scenario, for example, the liquid cooling loop may thereby be adapted to circulate the cooling fluid.

It will be appreciated that in the cases of the signals being provided via the fluid bus, that these signals may be implemented by acoustic waves coupled to the fluid bus, discussed further below.

Thus, the determination may be made regarding whether the first component is in fluid communication with the second component via a fluid bus.

If it is determined that the first component is in the fluid communication with the second component, the method may proceed to operation 306 following operation 304. Otherwise, the method may proceed to operation 308 following operation 304.

At operation 306, an acoustic wave is coupled to the fluid bus by the first component to direct the acoustic wave to the second component to transmit the portion of the data to the second component to manage the occurrence of the management event. The acoustic wave may be coupled to the fluid bus by (i) the acoustic wave being generated based on the portion of data, and (ii) the acoustic wave being provided via (e.g., through) the fluid bus.

For example, the acoustic wave may be generated by the first component using a transducer positioned with the first component. For example, assume the transducer is already acoustically coupled to a cooling fluid in the liquid cooling loop (e.g., fluid bus). Such coupling may be due to the transducer being implemented by one selected from a list consisting of, for example, (i) a piezoelectric component to generate the acoustic wave, (ii) an actuator to generate the acoustic wave, and/or (iii) any other kind of transducer implementation.

For example, the actuator may include a first portion positioned in the fluid bus and a second portion positioned outside of the fluid bus, the first portion being coupled to the second portion while at a distance from the second portion. This distance may be, for example, the thickness of a fluid line of the liquid cooling system (e.g., loop).

Therefore, as the first component generates the acoustic wave, the acoustic wave may be provided, via the fluid bus, by such an actuator being positioned with the fluid bus as mentioned above.

Additionally, however, it will be appreciated that the acoustic wave may be coupled to the fluid bus while acoustic conditions in the fluid bus meet criteria to do so. Such criteria may include, for example, the acoustic wave only being coupled to the fluid bus while the fluid bus is not under contention for communication use by other components of the system. Such contention may be screened, for example, in a similar manner as that discussed with regard to the previously made determination regarding whether the first component was in the fluid communication with the second component.

To manage communications via a fluid bus, use of the fluid bus may be managed using a communication scheme. The communication scheme may specify how data is to be encoded on carrier signals (e.g., may be amplitude shift keying, frequency shift keying, phase shift keying, and/or other types of encoding techniques), when the fluid bus may be utilized, how to handle collisions in use of the fluid bus by different users of the fluid bus, how to detect whether the fluid bus is in use for communication purposes, etc.

For example, to ascertain whether the fluid bus is in use, carrier sensing may be performed with respect to the fluid bus. During the carrier sensing, the fluid bus may be monitored for data transmissions encoded on acoustic carrier waves.

In another example, to ascertain whether the fluid bus may be utilized, a user of the fluid bus may send a request to send a transmission via the fluid bus and wait until a clear to send transmission has been received. Users of the fluid bus may monitor for presence of such transmissions to ascertain whether the fluid bus can be utilized.

In a further example, to ascertain whether a collision has occurred, users of the fluid bus may monitor the fluid bus for presence of other transmissions on the fluid bus (e.g., that may occur temporally with other transmissions thereby potentially preventing receipt of the transmitted data via corruption or other processes). The users may monitor the fluid bus for sudden changes in signal due to inference to identify when collision has occurred.

Additionally, in the event that a collision is identified, a fluid bus contention resolution process may be performed. During the contention resolution process, users of the fluid bus may all discontinue use of the fluid bus for communications and select waiting times (e.g., which may be random). Each of the users may wait the durations of the selected waiting times prior to attempting to use the fluid bus to communicate again. Consequently, the previously colliding users may be to use the bus at different times thereby eliminating collisions.

To manage and structure use of the fluid bus, a channel control scheme may be used which may require that messages be packetized (or framed) to be transmitted over the fluid bus. The packetized messages may include headers for channel management such as source, destination, sequence number, etc.

While described by way of example, the communication scheme may define other aspects of use of the fluid bus for communications without departing from embodiments disclosed herein.

The method may end following operation 306.

Returning to operation 304, if it is determined that the first component is not in the fluid communication with the second component via the fluid bus, the method may proceed to operation 308.

At operation 308, the portion of the data may be transmitted to the second component by some other means to manage the occurrence of the management event. The portion of the data may be transmitted by some other means such as by utilizing electronic components such as wired/wireless connections and/or intermediary-type components utilized by, for example, management controllers and/or other types of processors that may also be interconnected by wired/wireless connections.

Such use of these electronic components may be required should the portion of data need to be shared between components based on this occurrence of this management event. For example, any acoustic wave coupled to the cooling fluid by the first component may never be perceivable by the second component due to the second component not being able to physically sense (e.g., interact with) the acoustic wave coupled to the cooling fluid (e.g., the second component may be positioned with a second fluid bus that is not a same fluid bus to which an acoustic wave can be coupled to by the first component). For example, without the second component being in the fluid communication with the first component, any acoustic wave coupled to the cooling fluid by the first component may continue to flow through the loop without being receivable by vibration sensors of the second component. Any such acoustic wave may then continue to propagate within the loop.

The method may end following operation 308.

Using the method shown in FIG. 3, a likelihood of providing computer implemented services as desired by a consumer of such services may be increased. This may be due to the transmission of useful system information regarding operating conditions of the system via an already utilized liquid cooling system included in the system, rather than including additional electronics that may have otherwise created unnecessary crowding/complexity to the communication systems already utilized within the system.

Any of the processes and/or components illustrated in and/or discussed with regard to FIGS. 1A-3 may be implemented with and/or used in conjunction with one or more computing devices.

Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very-long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as an embedded controller (not shown) may control a keyboard or thermal sensor, dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components as such details are not germane to embodiments disclosed herein. It will also be appreciated that network computers, handheld computers, mobile phones, servers, and/or other data processing systems which have fewer components, or (perhaps) more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and (generally) conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a system, the method comprising:
making, by a first component of the system, an identification of an occurrence of a management event for the system; and
based on the identification:
obtaining, by the first component and based on the occurrence of the management event, a portion of data to transmit to a second component of the system;
making a determination regarding whether the first component and the second component are in fluid communication via a fluid bus; and
in a first instance of the determination where the first component and the second component are in the fluid communication via the fluid bus:
coupling, by the first component, an acoustic wave to the fluid bus to direct the acoustic wave to the second component to transmit the portion of the data to the second component to manage the occurrence of the management event.

2. The method of claim 1, wherein the fluid bus comprises a liquid cooling loop adapted to distribute cooling fluid to the first component and the second component.

3. The method of claim 2, wherein the liquid cooling loop is adapted to circulate the cooling fluid, and the acoustic wave is coupled to the cooling fluid by the first component.

4. The method of claim 2, wherein the first component is a cooling component, and the second component is a fluid flow control component.

5. The method of claim 4, wherein the fluid flow control component is a pump, and the cooling component is a cold plate positioned with a hardware component used by the system to provide desired computer implemented services.

6. The method of claim 4, wherein the acoustic wave is coupled to the fluid bus while the fluid bus is not under contention for communication use by other components of the system.

7. The method of claim 6, wherein the acoustic wave is coupled to the fluid bus while acoustic conditions in the fluid bus meet criteria.

8. The method of claim 1, further comprising:
generating, by the first component and using a transducer, the acoustic wave.

9. The method of claim 8, wherein the transducer is acoustically coupled to a cooling fluid in the fluid bus.

10. The method of claim 8, wherein the transducer comprises one selected from a list consisting of:
a piezoelectric component to generate the acoustic wave; and
an actuator to generate the acoustic wave.

11. The method of claim 10, wherein the actuator comprises:
a first portion positioned in the fluid bus, and
a second portion positioned outside of the fluid bus, the first portion being coupled to the second portion while at a distance from the second portion.

12. A non-transitory machine-readable medium having instructions stored therein, which when executed by a processor, cause the processor to perform operations for managing operation of a system, the operations comprising:
making, by a first component of the system, an identification of an occurrence of a management event for the system; and
based on the identification:
obtaining, by the first component and based on the occurrence of the management event, a portion of data to transmit to a second component of the system;
making a determination regarding whether the first component and the second component are in fluid communication via a fluid bus; and
in a first instance of the determination where the first component and the second component are in the fluid communication via the fluid bus:
coupling, by the first component, an acoustic wave to the fluid bus to direct the acoustic wave to the second component to transmit the portion of the data to the second component to manage the occurrence of the management event.

13. The non-transitory machine-readable medium of claim 12 wherein the operations further comprise:
generating, by the first component and using a transducer, the acoustic wave.

14. The non-transitory machine-readable medium of claim 13, wherein the transducer is acoustically coupled to a cooling fluid in the fluid bus.

15. The non-transitory machine-readable medium of claim 13, wherein the transducer comprises one selected from a list consisting of:
a piezoelectric component to generate the acoustic wave; and
an actuator to generate the acoustic wave.

16. The non-transitory machine-readable medium of claim 15, wherein the actuator comprises:
a first portion positioned in the fluid bus, and
a second portion positioned outside of the fluid bus, the first portion being coupled to the second portion while at a distance from the second portion.

17. A system, comprising:
a processor; and
a memory coupled to the processor to store instructions, which when executed by the processor, cause operations for managing operation of the system to be performed, the operations comprising:
making, by a first component of the system, an identification of an occurrence of a management event for the system; and
based on the identification:
obtaining, by the first component and based on the occurrence of the management event, a portion of data to transmit to a second component of the system;
making a determination regarding whether the first component and the second component are in fluid communication via a fluid bus; and
in a first instance of the determination where the first component and the second component are in the fluid communication via the fluid bus:
coupling, by the first component, an acoustic wave to the fluid bus to direct the acoustic wave to the second component to transmit the portion of the data to the second component to manage the occurrence of the management event.

18. The system of claim 17, wherein the operations further comprise:
generating, by the first component and using a transducer, the acoustic wave.

19. The system of claim 18, wherein the transducer is acoustically coupled to a cooling fluid in the fluid bus.

20. The system of claim 18, wherein the transducer comprises one selected from a list consisting of:
a piezoelectric component to generate the acoustic wave; and
an actuator to generate the acoustic wave.
